(19) United States
(12) Patent Application Publication
(10) Pub. No.: US 2024/0145786 A1
(43) Pub. Date: May 2, 2024

(54) BATTERY

(71) Applicant: Prime Planet Energy & Solutions, Inc., Tokyo (JP)

(72) Inventors: Yukinobu MIYAMURA, Kobe-shi (JP); Ryoichi WAKIMOTO, Kobe-shi (JP); Hiroaki IMANISHI, Kobe-shi (JP)

(21) Appl. No.: 18/470,422

(22) Filed: Sep. 20, 2023

(30) Foreign Application Priority Data
Oct. 28, 2022 (JP) 2022-173417

(51) Int. Cl. H01M 10/0587; H01M 50/11; H01M 50/183; H01M 50/593; H01M 50/636

(52) U.S. Cl. CPC H01M 10/0587; H01M 50/11; H01M 50/183; H01M 50/593; H01M 50/636

(57) ABSTRACT

A battery disclosed herein includes a wound electrode body, a battery case having a substantially rectangular first surface, and an electrolytic solution injection hole formed on the first surface of the battery case, a sealing member for sealing the electrolytic solution injection hole, and an insulating member fixed to the first surface. The electrolytic solution injection hole is formed in a position that does not overlap with vertexes of the curved portions of the plurality of wound electrode bodies. Herein, a part of the insulating member is disposed in a valley portion surrounded by a surface linking the vertexes of the adjacent wound electrode bodies and the curved surface of the curved portion of the adjacent wound electrode bodies, and a part of the sealing member is disposed in the valley portion.

### CROSS REFERENCE TO RELATED APPLICATION

The present application claims priority from Japanese Patent Application No. 2022-173417 filed on Oct. 28, 2022, which is incorporated by reference herein in its entirety.

### BACKGROUND OF THE DISCLOSURE

### 1. Field

The present disclosure relates to a battery.

### 2. Background

Conventionally known batteries include a battery including an electrode body including a positive electrode and a negative electrode, a battery case housing the electrode body, an electrolytic solution injection hole, and a sealing member for sealing the electrolytic solution injection hole (for example, Japanese Unexamined Patent Application, Publication No. 2011-76865 and PCT International Publication No. WO2012/105490). In such a battery, after an electrolytic solution is injected from the electrolytic solution injection hole, the electrolytic solution injection hole is sealed by the sealing member. For example, Japanese Unexamined Patent Application, Publication No. 2011-76865 mentions that sealing is carried out using a blind rivet as the sealing member. PCT International Publication No. WO2012/105490 describes disposing an electrolytic solution injection part that opens in a gap formed between a lid body and a curved portion of an electrode body.

### SUMMARY

However, as described in Japanese Unexamined Patent Application, Publication No. 2011-76865, when an electrolytic solution injection hole is sealed by a blind rivet, since a tip end of the rivet and the electrode body may be brought into contact with each other and may be damaged, a distance between the tip end of the rivet and the electrode body is required. Consequently, a length in the up-down direction of the wound electrode body is limited, and capacity may be prevented from increasing.

Furthermore, as described in PCT International Publication No. WO2012/105490, when an electrolytic solution injection part is disposed in a gap formed between a lid body and a curved portion of the electrode body, a distance between the electrode body and the sealing member can be shortened. Consequently, for example, when a vibration or the like is applied to a battery when the battery is manufactured or used, the sealing member and the electrode body may be easily brought into contact with each other and the electrode body may be damaged. The present disclosure has been made in view of this point, and an object thereof is to provide a battery that achieves higher capacity and improved reliability.

A battery disclosed herein includes a wound electrode body including a positive electrode and a negative electrode, and including a pair of curved portions; a battery case with a hexahedron shape housing a plurality of the wound electrode bodies, the battery case including a bottom surface, a first surface with a substantially rectangular shape facing the bottom surface, a pair of first side walls facing each other and extending from the bottom surface, and a pair of second side walls facing each other and extending from the bottom surface; an electrolytic solution injection hole formed on the first surface of the battery case; a sealing member for sealing the electrolytic solution injection hole; and an insulating member fixed to the first surface. The plurality of wound electrode bodies is disposed in the battery case in such a manner that in each of the plurality of wound electrode bodies, one curved portion of the pair of curved portions faces the first surface and another curved portion of the pair of curved portions faces the bottom surface. The electrolytic solution injection hole is formed in a position that does not overlap with vertexes of the curved portions of the plurality of wound electrode bodies. A part of the insulating member is disposed in a valley portion surrounded by a surface linking the vertexes of the adjacent wound electrode bodies and the curved surfaces of the curved portions of the adjacent wound electrode bodies. A part of the sealing member is disposed in the valley portion.

As mentioned above, when the sealing member is disposed in the valley portion surrounded by the curved surfaces of the adjacent wound electrode bodies, a length in the up-down direction of the wound electrode body can be increased, and high capacity of the battery can be achieved. In addition, in the battery having such a condition, a part of the insulating member is disposed in the valley portion. Therefore, even if impact or vibration is applied to a battery when the battery is manufactured or used, large movement of the wound electrode body can be suppressed, thus suppressing damage caused by contact between the sealing member disposed in the valley portion and the wound electrode body. Therefore, such a configuration can provide a battery in which a high capacity is achieved and reliability is further improved.

### BRIEF DESCRIPTION OF THE DRAWINGS

FIG. 1 is a perspective view schematically showing a battery in accordance with one embodiment;

FIG. 2 is a schematic longitudinal sectional view of the battery in accordance with one embodiment;

FIG. 3 is a schematic longitudinal sectional view along the line of FIG. 2;

FIG. 4 is a schematic lateral sectional view along the line IV-IV of FIG. 2;

FIG. 5 is a schematic view showing a configuration of a wound electrode body;

FIG. 6 is a perspective view schematically showing electrode bodies attached to a sealing plate;

FIG. 7 is a perspective view schematically showing an electrode body to which a positive electrode second current collecting member and a negative electrode second current collecting member are attached;

FIG. 8 is a longitudinal sectional view schematically showing a vicinity of an electrolytic solution injection hole of FIG. 3;

FIG. 9 is a longitudinal sectional view schematically showing a vicinity of a positive electrode of FIG. 2;

FIG. 10 is a perspective view schematically showing the sealing plate to which a positive electrode terminal, a negative electrode terminal, a positive electrode first current collecting member, a negative electrode first current collecting member, the positive electrode insulating member, and a negative electrode insulating member;

FIG. 11 is a perspective view of the sealing plate of FIG. 10 turned inside out;

FIG. 12 is a perspective view schematically showing a positive electrode insulating member;

FIG. 13 is a perspective view of the positive electrode insulating member of FIG. 12 turned inside out;

FIG. 14 is a view corresponding to FIG. 8 of a battery in accordance with a first modification; and

FIG. 15 is a view corresponding to FIG. 11 of a battery in accordance with a first modification.

### DETAILED DESCRIPTION OF THE PREFERRED EMBODIMENTS

Hereinafter, embodiments of the technology disclosed herein will be described with reference to drawings. Matters other than those specifically referred to in this specification that are necessary for implementation of the technology disclosed herein (for example, the general configurations and manufacturing processes of batteries that do not characterize the technology disclosed herein) may be understood as design matters of a person skilled in the art based on prior art in the field. The technology disclosed herein can be implemented based on the content disclosed in this specification and the common general technical knowledge in the field.

The term “battery” used in this specification refers to a concept encompassing a primary battery and a secondary battery. Furthermore, as used herein, the term “secondary battery” refers to any storage devices of being charged and discharged repeatedly by movement of charge carriers between a positive electrode and a negative electrode via electrolyte, and includes so-called storage batteries (chemical batteries) such as lithium-ion secondary batteries and nickel-metal hydride batteries.

In the following descriptions, reference numerals L, R, F, Rr, U, and D in the figures represent leftward, rightward, frontward, rearward, upward, and downward. Furthermore, in the drawings, the reference numeral X represents a “short side direction of a battery”, the symbol Y represents a “long side direction of a battery”, and the symbol Z represents an “up-down direction of a battery”. However, these are only for convenience of description and do not limit an installation form of a battery 100 at all.

### <Battery>

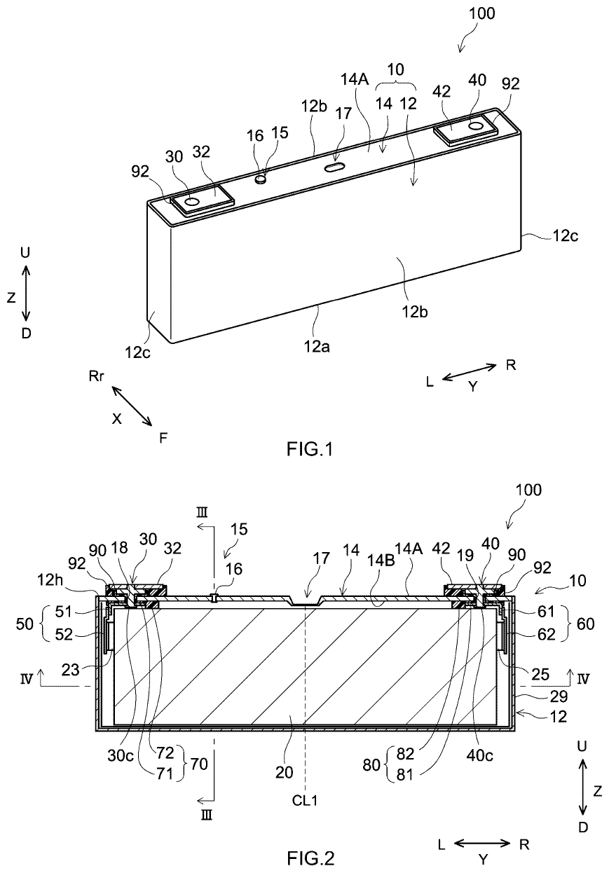

FIG. 1 is a perspective view of a battery 100. FIG. 2 is a schematic longitudinal sectional view of the battery 100. As shown in FIGS. 1 and 2, the battery 100 includes a wound electrode body 20, a battery case 10 for housing a wound electrode body 20, an electrolytic solution injection hole 15 disposed on a first surface (herein, a sealing plate 14) of the battery case 10, a sealing member 16 for sealing the electrolytic solution injection hole 15, and insulating members (herein, a positive electrode insulating member 70 and a negative electrode insulating member 80) fixed to the surface of the wound electrode body 20 in the first surface. Although not shown in the drawings, the battery 100 herein further includes an electrolytic solution. It is preferable that the battery 100 is, for example, a nonaqueous electrolyte secondary battery such as a lithium-ion secondary battery.

The battery case 10 is an enclosure for housing the wound electrode body 20. As shown in FIG. 1, the battery case 10 herein has an outer shape having a rectangular parallelepiped shape (hexahedron shape) with a bottom. The battery case 10 includes an outer covering 12 having an opening 12h, a sealing plate 14 for closing the opening 12h (see FIG. 2). The sealing plate 14 is an example of the first surface of the battery 100 shown herein. The battery case 10 is integrated by joining (for example, welding joining) the sealing plate 14 to a peripheral edge of the opening 12h of the outer covering 12. Joining of the sealing plate 14 can be carried out by welding, for example, laser welding. The battery case 10 is air-tightly sealed (hermetically closed).

As shown in FIG. 1, the outer covering 12 may include a bottom surface 12a, a pair of long side walls 12b facing each other and extending from the bottom surface 12a, and a pair of short side walls 12c facing each other and extending from the bottom surface 12a. An area of a short side wall 12c is smaller than that of the long side wall 12b. Herein, the long side wall 12b is an example of the first side walls, and the short side wall 12c is an example of the second side walls. Materials of the outer covering 12 may be the same as those conventionally used, and not particularly limited. The outer covering 12 is preferably made of metal. As an example, the outer covering 12 is preferably made of aluminum, an aluminum alloy, iron, an iron alloy, or the like.

The sealing plate 14 as the first surface is a substantially rectangular in a plan view. As shown in FIG. 1, the sealing plate 14 faces the bottom surface 12a. Herein, the transverse direction of the sealing plate 14 corresponds to the short side direction X of the battery 100, and the longitudinal direction of the sealing plate 14 corresponds to the long side direction Y of the battery 100. Furthermore, the sealing plate 14 is a plate member for closing the opening 12h of the outer covering 12. Materials of the sealing plate 14 may be the same as those conventionally used, and are not particularly limited. The sealing plate 14 is preferably made of metal. As an example, the sealing plate 14 is preferably made of aluminum, an aluminum alloy, iron, an iron alloy, or the like.

The sealing plate 14 includes the electrolytic solution injection hole 15. The electrolytic solution injection hole 15 is a through hole through which an electrolytic solution is to be injected into the inside of the battery case 10 after the sealing plate 14 is assembled to the outer covering 12. The electrolytic solution injection hole 15 penetrates through the sealing plate 14 in the up-down direction Z. The electrolytic solution injection hole 15 is sealed by the sealing member 16. Details of the electrolytic solution injection hole 15 and the sealing member 16 will be described later.

As shown in FIG. 2, the sealing plate 14 includes a gas discharge valve 17, and two terminal extraction holes 18 and 19. The gas discharge valve 17 is a thin part configured to be broken and to discharge gas inside the battery case 10 when a pressure inside the battery case 10 becomes a predetermined value or more. The terminal extraction holes 18 and 19 are formed on both end portions in the longitudinal direction of the sealing plate 14, respectively. The terminal extraction holes 18 and 19 are through holes penetrating the sealing plate 14 in the up-down direction Z, respectively.

The sealing plate 14 is provided with a positive electrode terminal 30 and a negative electrode terminal 40, respectively. The positive electrode terminal 30 is disposed at a first side in the long side direction Y of the sealing plate 14 (a left side in FIGS. 1 and 2). The negative electrode terminal 40 is disposed at a second side in the long side direction Y of the sealing plate 14 (a right side in FIGS. 1 and 2). The positive electrode terminal 30 and the negative electrode terminal 40 are examples of terminals disclosed herein. As shown in FIG. 1, first ends of the positive electrode terminal 30 and the negative electrode terminal 40 are exposed to the outside of the sealing plate 14 (an outer surface 14A side). Furthermore, as shown in FIG. 2, second ends of the positive electrode terminal 30 and the negative electrode terminal 40 are disposed inside the sealing plate 14 (an inner surface 14B side) in a state in which they are inserted into the terminal extraction holes 18 and 19. Although not particularly limited, the positive electrode terminal 30 and the negative electrode terminal 40 are caulked to a peripheral edge portion surrounding the terminal extraction holes 18 and 19 of the sealing plate 14 by caulking.

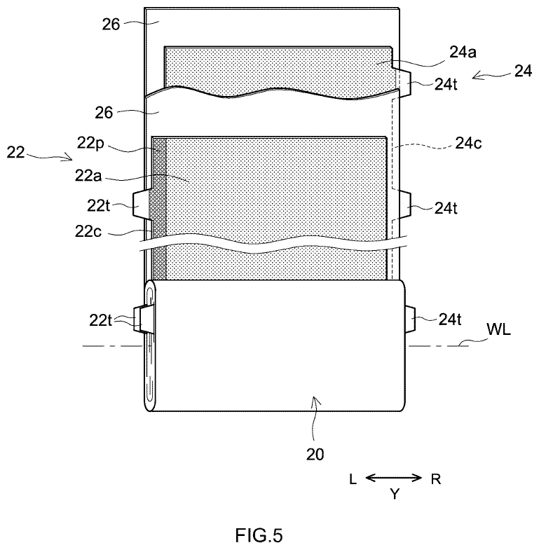

The positive electrode terminal 30 is preferably made of metal, and more preferably made of, for example, aluminum or an aluminum alloy. The negative electrode terminal 40 is preferably made of metal, and more preferably made of copper or a copper alloy. As shown in FIG. 2, a lower end portion 30c of the positive electrode terminal 30 is electrically coupled to a positive electrode 22 of the wound electrode body 20 via a positive electrode current collecting member 50 inside the outer covering 12 (see FIG. 5). A lower end portion 40c of the negative electrode terminal 40 is electrically coupled to a negative electrode 24 of the wound electrode body 20 via a negative electrode current collecting member 60 inside the outer covering 12 (see FIG. 5). As shown in FIG. 2, the positive electrode terminal 30 is insulated from the sealing plate 14 by the positive electrode insulating member 70, a gasket 90, and an outer insulating member 92. Furthermore, the negative electrode terminal 40 is insulated from the sealing plate 14 by the negative electrode insulating member 80, the gasket 90, and the outer insulating member 92. The positive electrode insulating member 70 and the negative electrode insulating member 80 are examples of the insulating members disclosed herein.

As shown in FIG. 1, to the outside surface (an outer surface 14A) of the sealing plate 14, a plate-shaped positive electrode external conductive member 32 and a negative electrode external conductive member 42 are attached. The positive electrode external conductive member 32 is electrically coupled to the positive electrode terminal 30. The negative electrode external conductive member 42 is electrically coupled to the negative electrode terminal 40. The positive electrode external conductive member 32 and the negative electrode external conductive member 42 are members to which a bus bar is attached when a plurality of batteries 100 is coupled to each other. The positive electrode external conductive member 32 and the negative electrode external conductive member 42 are preferably made of highly conductive metal, and made of, for example, aluminum, an aluminum alloy, copper, a copper alloy, or the like. The positive electrode external conductive member 32 and the negative electrode external conductive member 42 are insulated from the sealing plate 14 by the outer insulating member 92. However, the positive electrode external conductive member 32 and the negative electrode external conductive member 42 are not essential, and may be omitted in other embodiments.

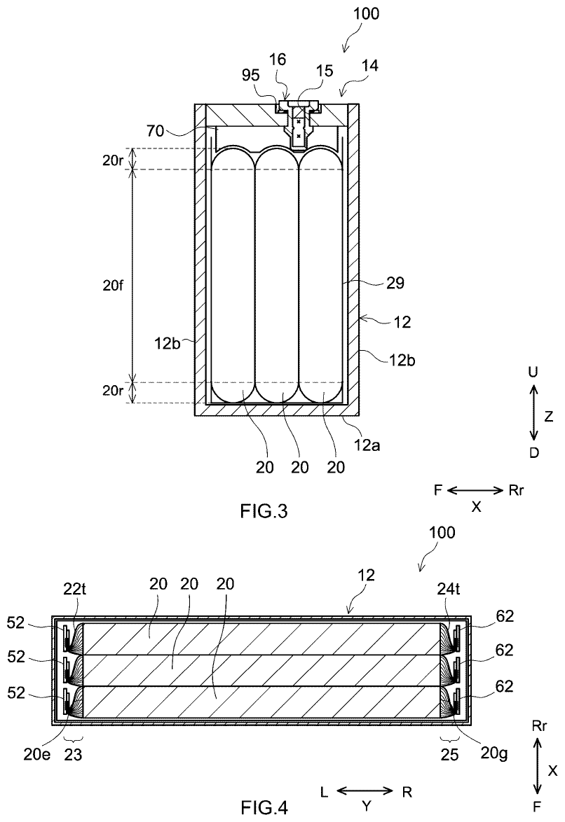

FIG. 3 is a schematic longitudinal sectional view taken along line III-III of FIG. 2. FIG. 4 is a schematic lateral sectional view taken along line IV-IV of FIG. 2. FIG. 5 is a view schematically showing a configuration of the wound electrode body 20. As shown in FIGS. 3 and 4, the battery 100 disclosed herein includes a plurality of the wound electrode bodies 20. Herein, the battery 100 includes three wound electrode bodies 20. However, the number of the wound electrode bodies 20 disposed inside the one outer covering 12 is not particularly limited as long as the number of plural (at least two or more), and the number may be an even number and may be an odd number. Note here that the plurality of wound electrode bodies 20 may have the same configuration.

As shown in FIG. 3, the wound electrode body 20 is preferably flat. Note here that in this specification, a flat wound electrode body is a wound electrode body having a substantially rectangular shape when viewed in a sectional view, and a so-called a racetrack shape (see FIG. 3). The wound electrode body 20 is, for example, flat, and includes a pair of curved portions 20r facing a first surface (herein, the sealing plate 14) and the bottom surface 12a of the outer covering 12, and a flat part 20f linking the pair of curved portions 20r and facing the long side wall 12b of the outer covering 12.

As shown in FIG. 3, the plurality of wound electrode bodies 20 is disposed inside the outer covering 12 to be covered with an electrode body holder 29 made of a resin sheet. One of the pair of curved portions 20r (the upper side in FIG. 3) herein indirectly faces the sealing plate 14 via a positive electrode first current collecting member 51, a negative electrode first current collecting member 61, the positive electrode insulating member 70, the negative electrode insulating member 80, and the like. Furthermore, another of the curved portions 20r (the lower side in FIG. 3) herein indirectly faces the bottom surface 12a via the electrode body holder 29.

The plurality of wound electrode bodies 20 is disposed inside the outer covering 12 such that the lamination direction of the wound electrode body 20 coincides with the short side direction X of the battery 100. The plurality of wound electrode bodies 20 is housed in the outer covering 12 in a direction in which the winding direction WL (see FIG. 5) is parallel to the long side direction Y of the battery 100. In other words, the plurality of wound electrode bodies 20 is preferably disposed inside the outer covering 12 with the winding axes WL thereof being parallel to each other. It is preferable that the plurality of wound electrode bodies 20 is disposed inside the outer covering 12 in which their winding axes WL are parallel, and the winding axes WL are in a direction perpendicular to the short side wall 12c. End surfaces (lamination surface on which the positive electrode 22 and the negative electrode 24 are laminated, an end surface in the long side direction Y in FIG. 5) of the plurality of wound electrode bodies 20 face the short side wall 12c.

As shown in FIG. 5, the wound electrode body 20 includes the positive electrode 22, the negative electrode 24, and a separator 26. The wound electrode body 20 is formed by laminating a belt-like positive electrode 22 and a belt-like negative electrode 24 with a belt-like separator 26 interposed therebetween, and winding the laminate around the winding axis WL.

The positive electrode 22 is a belt-like member as shown in FIG. 5. The positive electrode 22 (also referred to as a “positive electrode sheet 22”) includes a belt-like positive electrode current collector 22c, a positive electrode active material layer 22a fixed to at least one surface of the positive electrode current collector 22c, and a positive electrode protective layer 22p. However, the positive electrode protective layer 22p is not essential, and can be omitted in other embodiments. For members constituting the positive electrode sheet 22, conventionally known materials that can be used for general batteries (for example, lithium-ion secondary batteries) without limitation. The positive electrode current collector 22c is preferably made of a conductive metal such as, for example, aluminum, an aluminum alloy, nickel, stainless steel, or the like. The positive electrode current collector 22c herein is a metal foil, specifically an aluminum foil.

In the positive electrode 22, as shown in FIG. 5, to a first end portion (the left end portion in FIG. 5) in the long side direction Y of the wound electrode body 20, a plurality of positive electrode tabs 22t is provided. The plurality of positive electrode tabs 22t is provided along predetermined intervals (intermittently) in the longitudinal direction of the positive electrode current collector 22c. The positive electrode tabs 22t are coupled to the positive electrode 22. The positive electrode tabs 22t herein are a part of the positive electrode current collector 22c, and made of a metal foil (specifically, aluminum foil). Each of the positive electrode tab 22t is a region in which the positive electrode active material layer 22a is not provided and the positive electrode current collector 22c is exposed. However, the positive electrode tab 22t may be provided partly with the positive electrode active material layer 22a and/or the positive electrode protective layer 22p, and may be a member that is different from the positive electrode current collector 22c. Each of the plurality of positive electrode tabs 22t herein has a trapezoidal shape. However, the shape of the positive electrode tab 22t is not limited to this. Furthermore, the sizes of the plurality of positive electrode tabs 22t are not particularly limited. The shapes and sizes of the positive electrode tabs 22t can be appropriately adjusted according to, for example, the position where they are formed in consideration of the state in which they are connected to the positive electrode current collecting member 50. As shown in FIG. 4, the plurality of positive electrode tabs 22t is laminated on one end portion (a left end portion in FIG. 4) in the long side direction Y of battery 100 to form a positive electrode tab group 23.

As shown in FIG. 5, the positive electrode active material layer 22a is provided in a belt shape along the longitudinal direction of the belt-like positive electrode current collector 22c. The positive electrode active material layer 22a includes a positive electrode active material (for example, lithium transition metal complex oxides such as lithium nickel cobalt manganese complex oxides) that can reversibly absorb and release charge carriers. When the total solid content of the positive electrode active material layer 22a is 100% by mass, the content of the positive electrode active material may be appropriately 80% by mass or more, typically 90% by mass or more, and, for example, 95% by mass or more. The positive electrode active material layer 22a may include optional components other than the positive electrode active materials, for example, a conductive material, a binder, various additive components, and the like. An example of the conductive material is a carbon material such as acetylene black (AB). An example of the binder is a fluorine-based resin such as polyvinylidene fluoride (PVdF).

As shown in FIG. 5, the positive electrode protective layer 22p is provided in a boundary part between the positive electrode current collector 22c and the positive electrode active material layer 22a in the long side direction Y. The positive electrode protective layer 22p herein is provided in one end portion (the left end portion in FIG. 5) in the width direction of the positive electrode current collector 22c. However, the positive electrode protective layer 22p may be provided on both end portions in the width direction. The positive electrode protective layer 22p includes insulating inorganic fillers, for example, ceramic particles such as alumina. When the total solid content of the positive electrode protective layer 22p is 100% by mass, the content of the inorganic filler may be appropriately 50% by mass or more, typically 70% by mass or more, and, for example, 80% by mass or more. The positive electrode protective layer 22p may include optional components other than the inorganic filler, for example, a conductive material, a binder, various additive components, and the like. The conductive material and binders may be the same as those that can be contained in the positive electrode active material layer 22a.

As shown in FIG. 5, the negative electrode 24 is a belt-like member. The negative electrode 24 (also referred to as a “negative electrode sheet 24”) includes a belt-like negative electrode current collector 24c, and a negative electrode active material layer 24a fixed to at least one surface of the negative electrode current collector 24c. For the members constituting the negative electrode sheet 24, conventionally known materials that can be used as general batteries (for example, lithium-ion secondary batteries) can be used without limitation. For example, the negative electrode current collector 24c is preferably made of copper, a copper alloy, nickel, stainless steel, or the like. The negative current collector 24c herein is a metal foil, specifically, a copper foil.

In the negative electrode 24, as shown in FIG. 5, to one end portion (a right end portion in FIG. 5) in the long side direction Y of the wound electrode body 20, a plurality of negative electrode tabs 24t is provided. The plurality of negative electrode tabs 24t is provided along the longitudinal direction of the negative electrode current collector 24c at predetermined intervals (intermittently). The negative electrode tabs 24t are coupled to the negative electrode 24. The negative electrode tabs 24t herein are a part of the negative electrode current collector 24c, and made of metal foils (specifically, a copper foil). The negative electrode tabs 24t herein are a region in which the negative electrode active material layer 24a is not formed and the negative electrode current collector 24c is exposed. However, the negative electrode tabs 24t may be partially provided with the negative electrode active material layer 24a, or may be members other than the negative electrode current collector 24c. The plurality of negative electrode tabs 24t herein has a trapezoidal shape. However, the shapes or sizes of the plurality of negative electrode tabs 24t can be appropriately adjusted similar to those of the positive electrode tabs 22t. As shown in FIG. 4, the plurality of negative electrode tabs 24t is laminated on one end portion (the right end portion in FIG. 4) in the long side direction Y of the negative electrode sheet 24 to form a negative electrode tab group 25.

As shown in FIG. 5, the negative electrode active material layer 24a is provided in a belt shape in the longitudinal direction of the belt-like negative electrode current collector 24c. The negative electrode active material layer 24a includes a negative electrode active material (for example, carbon materials such as graphite) that can reversibly absorb and release charge carriers. The width (the length in the long side direction Y. The same is true to the followings.) of the negative electrode active material layer 24a is preferably larger than the width of the positive electrode active material layer 22a. When the total solid content of the negative electrode active material layer 24a is 100% by mass, the content of the negative electrode active material may be appropriately 80% by mass or more, typically 90% by mass or more, and, for example, 95% by mass or more. The negative electrode active material layer 24a may include optional components other than the negative electrode active materials, for example, a conductive material, a binder, a dispersant, various additive components, and the like. Examples of the binder include rubbers such as styrene-butadiene rubber (SBR). Examples of the dispersants include cellulose such as carboxymethyl cellulose (CMC).

The separator 26 is a member that insulates the positive electrode active material layer 22a of the positive electrode 22 and the negative electrode active material layer 24a of the negative electrode 24 from each other. Suitable examples of the separator 26 include a resin porous sheet made of polyolefin resins such as polyethylene (PE) and polypropylene (PP). The separator 26 herein includes a base material part including a porous sheet made of resin and a heat resistance layer (HRL) formed on at least one surface of the base material part. The heat resistance layer is typically a layer including an inorganic filler and a binder. Examples of the inorganic fillers include alumina, boehmite, aluminum hydroxide, titania, or the like. Examples of the binders include polyvinylidene fluoride (PVdF) or the like.

Furthermore, the battery case 10 can house an electrolytic solution together with the wound electrode body 20 as mentioned above. As the electrolytic solution, those that can be used in conventionally known batteries can be used without limitation. An example of the electrolytic solution is a nonaqueous electrolytic solution in which a support salt is dissolved in a nonaqueous solvent. Examples of the nonaqueous solvents include carbonate-based solvents such as ethylene carbonate, dimethyl carbonate, and ethyl methyl carbonate. Examples of the support salt include a fluorine-containing lithium salt such as LiPF₆. The nonaqueous electrolytic solution may contain various additives as needed.

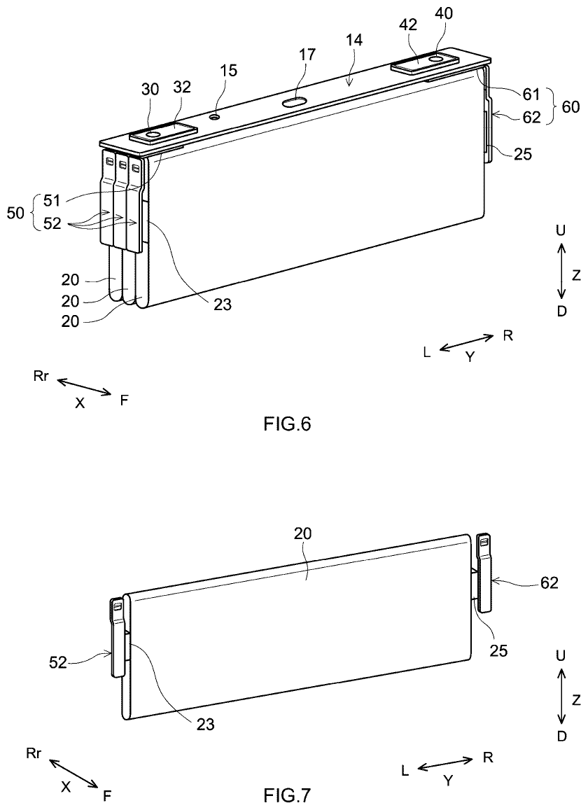

FIG. 6 is a perspective view schematically showing the plurality of wound electrode bodies 20 attached to the sealing plate 14. FIG. 7 is a perspective view schematically showing the wound electrode body 20. As shown in FIG. 6, the positive electrode tab group 23 of each of the plurality of wound electrode bodies 20 is coupled to the positive electrode terminal 30 via the positive electrode current collecting member 50. The positive electrode current collecting member 50 is housed inside the battery case 10. As shown in FIG. 2 and FIG. 6, the positive electrode current collecting member 50 includes the positive electrode first current collecting member 51 and a positive electrode second current collecting member 52. The configuration of the positive electrode first current collecting member 51 will be described later. As shown in FIG. 6 and FIG. 7, the positive electrode second current collecting member 52 is a plate-shaped conductive member extending in the up-down direction Z of the battery 100. As shown in FIG. 2, the lower end portion 30c of the positive electrode terminal 30 is inserted into the inside of the battery case 10 through a terminal extraction hole 18 of the sealing plate 14, and coupled to the positive electrode first current collecting member 51. Furthermore, as shown in FIG. 4 and FIG. 6, herein, the battery 100 includes the positive electrode second current collecting members 52. The number of the positive electrode second current collecting members 52 corresponds to the number of the plurality of wound electrode bodies 20. Each of the positive electrode second current collecting members 52 is coupled to the corresponding positive electrode tab group 23 of the plurality of wound electrode bodies 20. Then, as shown in FIG. 4, the positive electrode tab group 23 of the wound electrode body 20 is bent such that the positive electrode second current collecting member 52 face one side surface 20e of the wound electrode body 20. Thus, the positive electrode second current collecting member 52 and the positive electrode first current collecting member 51 are electrically coupled to each other. Note here that the positive electrode current collecting member 50 is preferably made of metals with excellent conductivity, and can be made of, for example, aluminum or an aluminum alloy.

On the other hand, the negative electrode tab group 25 of each of the plurality of wound electrode bodies 20 is coupled to the negative electrode terminal 40 via the negative electrode current collecting member 60. The coupling structure of the negative electrode side is substantially the same as the coupling structure of the positive electrode side described above. Specifically, as shown in FIG. 2 and FIG. 6, the negative electrode current collecting member 60 includes the negative electrode first current collecting member 61 and the negative electrode second current collecting member 62. The configuration of the negative electrode first current collecting member 61 will be described later. As shown in FIG. 6 and FIG. 7, the negative electrode second current collecting member 62 is a plate-shaped conductive member extending in the up-down direction Z of the battery 100. As shown in FIG. 2, the lower end portion 40c of the negative electrode terminal 40 is inserted into the inside of the battery case 10 through the terminal extraction hole 19 and coupled to the negative electrode first current collecting member 61. Furthermore, as shown in FIG. 4 and FIG. 6, herein, the battery 100 includes plurality of wound electrode bodies 20. The number of the negative electrode second current collecting members 62 corresponds to the number of the plurality of wound electrode bodies 20. Each of the negative electrode second current collecting member 62 is coupled to the corresponding negative electrode tab group 25 of the plurality of wound electrode bodies 20. Then, as shown in FIG. 4, the negative electrode tab group 25 of the wound electrode body 20 is bent such that the negative electrode second current collecting member 62 face another side of side surface 20g of the wound electrode body 20. Thus, the negative electrode second current collecting member 62 and the negative electrode first current collecting member 61 are electrically coupled to each other. Note here that the negative electrode current collecting member 60 is preferably made of metals with excellent conductivity, and can be made of, for example, copper or a copper alloy.

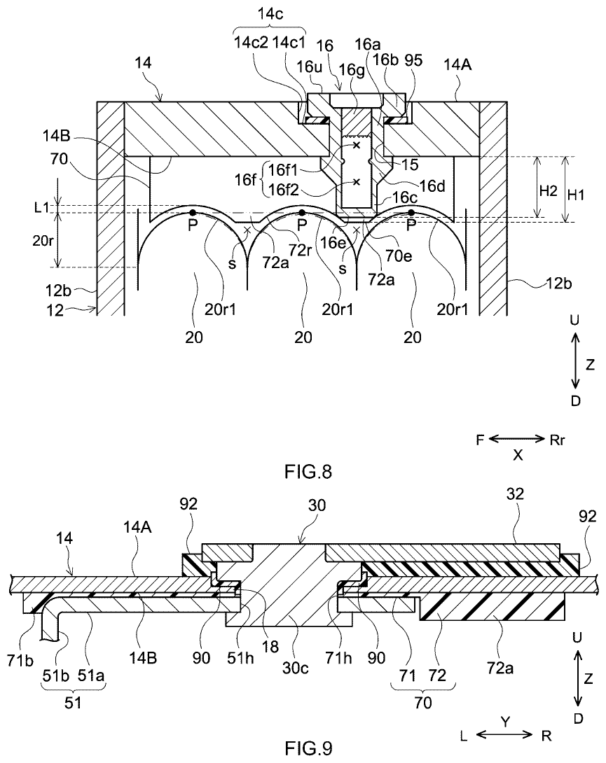

FIG. 8 is a partial sectional view schematically showing a vicinity of the electrolytic solution injection hole 15 of FIG. 3. FIG. 9 is a partial sectional view schematically showing a vicinity of the positive electrode terminal 30 of FIG. 2. As shown in FIG. 8, in the battery 100 disclosed herein, for the purpose of achieving high capacity, the electrolytic solution injection hole 15 is formed in a position so as not to overlap with vertexes P of the wound electrode bodies 20, and a part of the sealing member 16 for sealing the electrolytic solution injection hole 15 is disposed on a valley portion S shown by a virtual line. As shown in FIG. 8, herein, the valley portion S is a region formed by a straight line linking the vertexes P of two adjacent winding electrode bodies 20 and a curved surface 20r1 of the curved part 20r in a longitudinal sectional view along the winding axis WL of the winding electrode body 20. Thus, since the height of the wound electrode body 20 (the length in the up-down direction Z. The same is true to the followings.) can be increased, high capacity of the battery 100 can be achieved. Furthermore, as shown in FIG. 9, in the battery 100 disclosed herein, the positive electrode insulating member 70 is disposed between the sealing plate 14 and the positive electrode first current collecting member 51 in the up-down direction Z. Then, at least a part of the positive electrode insulating member 70 is disposed in the valley portion S mentioned above (see FIG. 8). Since at least a part of the positive electrode insulating member 70 is disposed in such a valley portion S, large movement of the wound electrode body 20 is suppressed inside the battery case 10. Therefore, even if the sealing member 16 is disposed in the valley portion S, and a distance with respect to the wound electrode body 20 becomes shorter, the wound electrode body 20 is prevented from largely moving and coming into contact with and damaging the sealing member 16 because a part of the insulating member is disposed in the valley portion S. Therefore, a battery 100 achieving high capacity and high reliability can be provided.

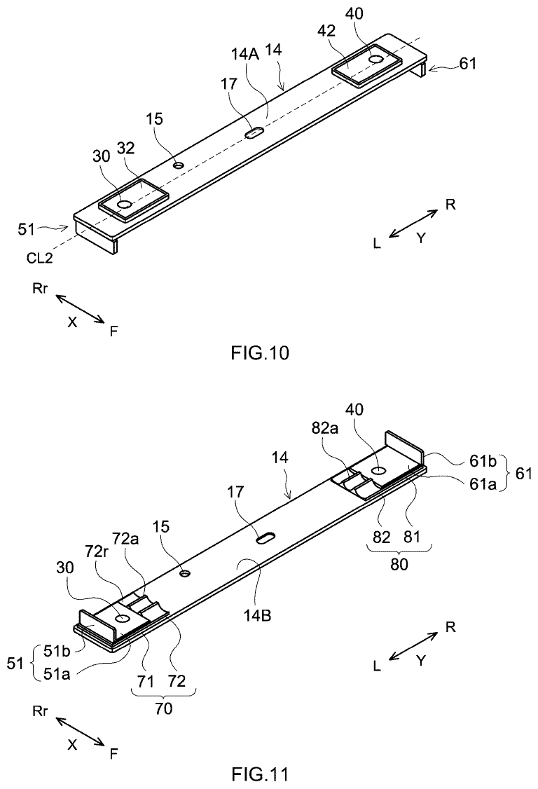

FIG. 10 is a perspective view schematically showing the sealing plate 14. FIG. 11 is a perspective view of the sealing plate 14 of FIG. 10 turned inside out. FIG. 11 shows a surface at the side of the outer covering 12 (the inner side) of the sealing plate 14. As shown in FIG. 10 and FIG. 11, the sealing plate 14 includes the electrolytic solution injection hole 15. The electrolytic solution injection hole 15 is herein formed in a substantially circular shape in a plan view. In the battery 100 disclosed herein, in the sealing plate 14, the electrolytic solution injection hole 15 is formed at a position facing the valley portion S described above. For example, when the battery 100 includes odd number (herein, three) of the wound electrode bodies 20, the valley portion S is not formed in a position facing a center line CL2 in the transverse direction of the sealing plate 14. Therefore, when the battery 100 includes odd number of the wound electrode bodies 20, the electrolytic solution injection hole 15 is not provided on the center line CL2 of the sealing plate 14. By providing the electrolytic solution injection hole 15 in a position facing the valley portion S, a part of the sealing member 16 may be disposed in the valley portion S. Therefore, the height of the wound electrode body 20 can be increased, and the capacity of the battery 100 can be increased. However, when the battery 100 includes even number (for example, two) of the wound electrode bodies 20, the valley portion S can be formed in a position facing the center line CL2 of the sealing plate 14. In this case, the electrolytic solution injection hole 15 may be provided on the center line CL2 of the sealing plate 14.

As shown in FIG. 8, the outer surface 14A of the sealing plate 14 may be provided with a recessed portion 14c. The recessed portion 14c is provided to surround the periphery of the electrolytic solution injection hole 15. The recessed portion 14c is formed herein in a substantially circular shape larger than the electrolytic solution injection hole 15 in a plan view. In a plan view, the center of recessed portion 14c coincides with the center of the electrolytic solution injection hole 15. The recessed portion 14c is recessed from the outer surface 14A side toward the inner surface 14B side in the sealing plate 14. The recessed portion 14c includes a bottom surface 14c1 and a side wall 14c2. The bottom surface 14c1 herein is substantially parallel to the inner surface 14B side of the sealing plate 14. The side wall 14c2 rises upward from the outer peripheral edge of the bottom surface 14c1 along the up-down direction Z.

The electrolytic solution injection hole 15 is sealed by the sealing member 16 after the electrolytic solution is injected. The sealing member 16 is typically made of metal. The sealing member 16 is preferably, but not particularly limited to, a rivet, and more preferably a blind rivet. As shown in, for example, FIG. 8, in the sealing member 16, an upper end portion 16u is exposed to the outside of the battery case 10, and a lower end portion 16e protrudes to the inside of the battery case 10. The sealing member 16 includes an inserted portion 16a, a collar portion 16b, and an enlarged diameter portion 16c. The inserted portion 16a of the sealing member 16 is inserted into the electrolytic solution injection hole 15. The sealing member 16 is fixed by caulking to the sealing plate 14 by the collar portion 16b and the enlarged diameter portion 16c in a process in which the sealing member 16 is placed on the electrolytic solution injection hole 15. Note here that the sealing member 16 is not necessarily required to have the shape mentioned above. Furthermore, the sealing member 16 may not necessarily fixed by caulking, and the sealing member 16 may be joined by welding the sealing member 16 to the sealing plate 14.

The inserted portion 16a is a portion inserted into the electrolytic solution injection hole 15. An outer diameter of the inserted portion 16a is smaller than that of the electrolytic solution injection hole 15. The inserted portion 16a is a cylindrical portion having an inner cavity 16f. The inner cavity 16f includes a first cavity portion 16f1 formed in the upper part of the inserted portion 16a, and a second cavity portion 16f2 formed in the lower part of the inserted portion 16a. To the first cavity portion 16f1, a head portion 16g of a mandrel is housed. The mandrel is a rod-shaped member extending from the upper surface of the head portion 16g upward in the up-down direction Z. Although mentioned later, since the mandrel is removed in a process of placing the sealing member 16 in the electrolytic solution injection hole 15, the mandrel is not shown in FIG. 8.

The collar portion 16b protrudes to the outside of the battery case 10 from the electrolytic solution injection hole 15. The collar portion 16b is placed on the outer surface 14A of the sealing plate 14. The collar portion 16b may be formed in a substantially circular shape or a substantially quadrangular shape in a plan view. Herein, the outer diameter of the collar portion 16b is smaller than the diameter of the recessed portion 14c of the sealing plate 14 in a plan view.

The enlarged diameter portion 16c extends from a lower end of the inserted portion 16a toward the bottom surface 12a side (an opposite side to the collar portion 16b). An outer diameter of the enlarged diameter portion 16c is larger than the outer diameter of the electrolytic solution injection hole 15. Thus, the electrolytic solution injection hole 15 is sealed by the sealing member 16. In the technology disclosed herein, a part of the sealing member 16 (herein, the enlarged diameter portion 16c) is disposed in a valley portion shown by a virtual line in FIG. 8. When the enlarged diameter portion 16c of the sealing member 16 is disposed in the valley portion S, as compared with the case where the enlarged diameter portion 16c is formed in a position facing the vertex P of the wound electrode body 20, the height of the wound electrode body 20 can be increased. Therefore, higher capacity of the battery 100 can be achieved.

Furthermore, although not particularly limited, as shown in FIG. 8, the enlarged diameter portion 16c preferably includes a maximum width portion 16d with maximum diameter in the upper part (that is, in the vicinity of the sealing plate 14). In other words, the sealing member 16 protrudes toward the inside of the battery case 10 as mentioned above, and preferably has the maximum width portion 16d at a sealing plate 14 side in the protruding direction. Thus, the electrolytic solution injection hole 15 can be sealed more airtightly. Furthermore, the sealing member 16 is easily fitted into the shape of the valley portion S. Therefore, the height of the wound electrode body 20 can be more increased, and the capacity of the battery 100 can be more increased.

Furthermore, as shown in FIG. 8, a seal member 95 may be provided between the sealing member 16 and the sealing plate 14. Thus, the electrolytic solution injection hole 15 is sealed more airtightly. The seal member 95 is preferably made of a resin member. Examples of such resin members include polyolefin resins such as polypropylene (PP) and polyethylene (PE), fluorine resins such as perfluoroalkoxyalkanes and polytetrafluoroethylene (PTFE), polyphenylene sulfide (PPS), and the like.

As shown in FIGS. 9 to 11, the positive electrode first current collecting member 51 is attached to the inner surface 14B side of the sealing plate 14. The negative electrode first current collecting member 61 is also attached to the inner surface 14B side of the sealing plate 14. The positive electrode first current collecting member 51 and the negative electrode first current collecting member 61 are examples of the current collecting member disclosed herein. In the battery 100 disclosed herein, in the up-down direction Z, insulating members (herein, the positive electrode insulating member 70 and the negative electrode insulating member 80) are disposed between the sealing plate 14 and a current collecting member (herein, the positive electrode first current collecting member 51 and the negative electrode first current collecting member 61). Thus, the sealing plate 14 and current collecting member are insulated by the insulating member. Note here that in the following, a configuration of the positive electrode terminal 30 side will be described in detail, but a configuration of the negative electrode terminal 40 side can be almost the same.

As shown in FIG. 9, the positive electrode first current collecting member 51 includes a first region 51a and a second region 51b. The positive electrode first current collecting member 51 may be constructed by bending a single member by press working or the like or by integrating a plurality of members by weld joining or the like. The positive electrode first current collecting member 51 herein is fixed by caulking to an inner surface 14B of the sealing plate 14. The first region 51a is a site disposed between the sealing plate 14 and the wound electrode body 20. The first region 51a extends in the long side direction Y. The first region 51a spreads horizontally along the inner surface 14B of the sealing plate 14. Herein, the first region 51a is electrically coupled by caulking to the positive electrode terminal 30. In the first region 51a, in a position corresponding to the terminal extraction hole 18 of the sealing plate 14, a through hole 51h penetrating in the up-down direction Z is formed. The second region 51b extends from one end in long side direction Y of the first region 51a (the left end in FIG. 9) along the short side wall 12c of the outer covering 12. In other words, the second region 51b extends in the up-down direction Z.

The positive electrode insulating member 70 insulates the first region 51a of the positive electrode first current collecting member 51 from the sealing plate 14. The positive electrode insulating member 70 can be made of a resin material which has resistance with respect to an electrolyte solution to be used and an electrical insulating property and which is capable of elastic deformation. Examples of the resin material include polyolefin resins such as polypropylene (PP) and polyethylene (PE), fluorine resins such as tetrafluoroethylene-perfluoroalkoxy ethylene copolymer (PFE) and polytetrafluoroethylene (PTFE), polyphenylene sulfide (PPS), and the like.

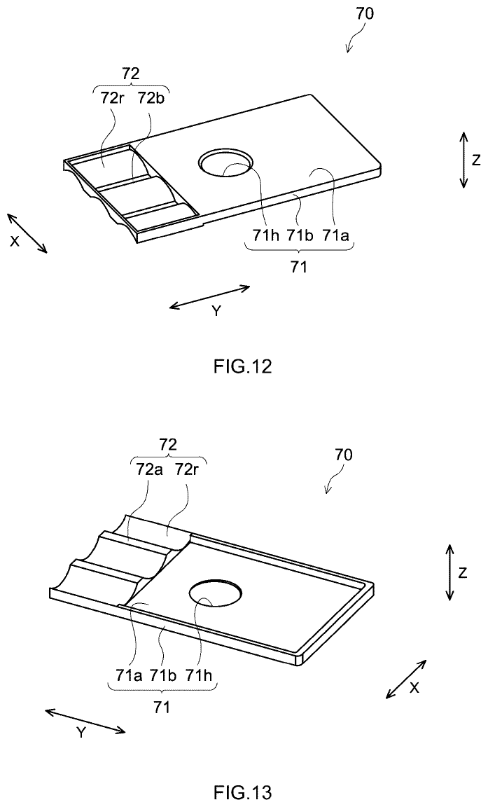

FIG. 12 is a perspective view of the positive electrode insulating member 70. FIG. 13 is a perspective view of the positive electrode insulating member 70 of FIG. 12 turned inside out. FIG. 13 shows a surface at a side facing the wound electrode body 20 of the positive electrode insulating member 70. As shown in FIG. 12 and FIG. 13, the positive electrode insulating member 70 includes a base region 71 and a protruding portion formation region 72. The base region 71 and the protruding portion formation region 72 are herein integrally molded. The positive electrode insulating member 70 is an integrally molded product obtained by integrally molding the resin material. This can reduce the number of members to be used as compared with a case where the base region 71 and the protruding portion formation region 72 are different members, and can reduce the cost. Note here that the base region 71 and the protruding portion formation region 72 may be made of different members.

As shown in FIG. 9, the base region 71 is a region disposed between the sealing plate 14 and the positive electrode first current collecting member 51 in the up-down direction Z. In other words, the base region 71 is a region that faces the current collecting member (herein, the positive electrode first current collecting member 51). The base region 71 spreads horizontally along the first region 51a of the positive electrode first current collecting member 51. As shown in FIG. 12 and FIG. 13, the base region 71 includes a main body portion 71a, a wall portion 71b, and a through hole 71h. The main body portion 71a faces the upper surface of the first region 51a of the positive electrode first current collecting member 51. The wall portion 71b is provided around the main body portion 71a. The wall portion 71b is a region extending from the peripheral edge of the main body portion 71a along the up-down direction Z. The wall portion 71b faces the side surface of the first region 51a. The through hole 71h penetrates through the main body portion 71a in the up-down direction Z. The through hole 71h is formed in a position corresponding to the terminal extraction hole 18 of the sealing plate 14.

As shown in FIG. 9, the protruding portion formation region 72 is provided on the central side (a right side of FIG. 9) with respect to the base region 71 in the longitudinal direction of the sealing plate 14. In other words, the protruding portion formation region 72 is a region that faces the wound electrode body 20, and that does not face the current collecting member (herein, the positive electrode first current collecting member 51). As shown in FIG. 11 and FIG. 13, the protruding portion formation region 72 includes a protruding portion 72a. The protruding portion 72a is a site protruding from the sealing plate 14 side to the wound electrode body 20 side. In more detail, the protruding portion 72a is a site protruding toward the valley portion S mentioned above. The protruding portion 72a protrudes toward the side closer to the wound electrode body 20 than the wall portion 71b of the base region 71.

As shown in FIG. 8, in the battery 100 disclosed herein, the protruding portion 72a is preferably disposed in the valley portion S mentioned above. Thus, movement of the wound electrode body 20 in the left and right direction (the short side direction X of FIG. 8) is suitably suppressed, the position of the wound electrode body 20 can be fixed inside the battery case 10. Therefore, as mentioned above, even if the sealing member 16 is disposed in the valley portion S for the purpose of increasing the capacity, largely moving of the wound electrode body 20 and coming into contact with and damaging the sealing member 16 can be suppressed. Therefore, with the battery 100 disclosed herein, a battery achieving high capacity and reliability can be achieved. The shape of the protruding portion 72a is not particularly limited as long as the protruding portion 72a can be disposed in the valley portion S. For example, in a sectional view, the shape may be a trapezoidal shape or a rectangular U-shape or a triangle shape or a semicircular shape.

The protruding portion formation region 72 herein includes a plurality of the protruding portions 72a. The number of the protruding portions 72a formed in the protruding portion formation region 72 is the same number as the number of the valley portions (that is, two). Thus, the plurality of the protruding portions 72a can be suitably disposed in the valley portion S, and largely moving of the wound electrode body 20 inside the battery case 10 can be suppressed. However, the number of the protruding portions 72a is not particularly limited. The number of protruding portions 72a may be one, or three or more. Preferably, a plurality of the protruding portions 72a is formed in the protruding portion formation region 72. When the protruding portion formation region 72 includes a plurality of the protruding portions 72a, the plurality of the protruding portions 72a is preferably arranged in the short side direction X in the protruding portion formation region 72.

As shown in FIG. 13, the protruding portion formation region 72 of the positive electrode insulating member 70 preferably includes a plurality of curved surfaces 72r in addition to a plurality of the protruding portions 72a in the surface facing the wound electrode body 20. This can suppress large movement of the wound electrode body 20 in the up-down direction and can provide a battery 100 with higher reliability. The plurality of curved surfaces 72r can be formed among the plurality of protruding portions 72a. From the viewpoint of further suitably suppressing the movement of the wound electrode body 20 in the up-down direction, the curved surface 72r of the positive electrode insulating member 70 preferably has a shape along the curved surface 20r1 of the wound electrode body 20.

The plurality of curved surfaces 72r may be or may not be in contact with the wound electrode body 20. Preferably, as shown in FIG. 8, the plurality of curved surfaces 72r may be disposed in a position apart from the wound electrode body 20. In other words, a slight gap may be provided between the plurality of curved surfaces 72r and the curved portion 20r of the wound electrode body 20. Providing a clearance between the wound electrode body 20 and the insulating member facilitates assembly process of the battery 100. Furthermore, for example, even when the wound electrode body 20 is expanded by charge and discharge, the wound electrode body 20 is not easily pressed by the presence of the clearance. Although not particularly limited, the shortest length L1 between the curved surface 72r of the positive electrode insulating member 70 and the curved portion 20r of the wound electrode body 20 (see FIG. 8) is preferably 0.3 mm or more and 2 mm or less, and more preferably 0.5 mm or more and 1 mm or less.

Although not particularly limited, as shown in FIG. 12, on a surface at the side facing the sealing plate 14 of the protruding portion formation region 72, a recessed portion 72b is preferably formed. Such a recessed portion 72b can be formed in a position facing the protruding portion 72a. By forming the recessed portion 72b, it is possible to increase a volume in which gas can exist inside the battery case 10. Thus, the increase in internal pressure during gas generation, and the like, can be moderated.

As shown in FIG. 2, the negative electrode insulating member 80 is disposed at a position that is symmetrical to the positive electrode insulating member 70 with respect to the center CL1 in the long side direction Y of the wound electrode body 20. The configuration of the negative electrode insulating member 80 may be the same as the configuration of the positive electrode insulating member 70. The negative electrode insulating member 80 herein includes, similar to the positive electrode insulating member 70, a base region 81 and the protruding portion formation region 82, the protruding portion formation region 82 includes a plurality of protruding portions 82a (see FIG. 11).

The battery 100 preferably includes both the positive electrode insulating member 70 and the negative electrode insulating member 80. Thus, even if vibration, impact, or the like, is applied when the battery 100 is transported or used, large movement of the wound electrode body 20 can be suppressed. Therefore, the wound electrode body 20 is prevented from being damaged, and a battery 100 with high reliability can be achieved.

As shown in FIG. 8, in the battery 100 disclosed herein, a lower end portion 70e of the positive electrode insulating member 70 is preferably disposed in the lower part than the lower end portion 16e of the sealing member 16 (the bottom surface 12a side of the battery case 10). In other words, a length H1 of the protruding portion 72a of the positive electrode insulating member 70 in the up-down direction Z is preferably longer than the length H2 of the enlarged diameter portion 16c in the up-down direction Z. Thus, even if vibration is applied to battery 100 when the battery 100 is manufactured or the battery 100 is used, since the wound electrode body 20 is brought into contact with the lower end portion 70e of the positive electrode insulating member 70, the wound electrode body 20 is not easily brought into contact with the lower end portion 16e of the sealing member 16, damage of the wound electrode body 20 can be suppressed. In particular, when the sealing member 16 is made of metal, and the positive electrode insulating member 70 is resin, the wound electrode body 20 can be effectively protected. Therefore, the lower end portion 70e of the positive electrode insulating member 70 is disposed near the bottom surface 12a side than the lower end portion 16e of the sealing member 16, the battery 100 with higher reliability can be achieved. It is preferable that the length H1 of the protruding portion 72a is, for example, longer than the length H2 of the enlarged diameter portion 16c by 0.1 mm or more, and more preferably longer by 0.2 mm or more.

### <Method for Manufacturing Battery>

In a battery 100 disclosed herein, a sealing plate 14 includes an electrolytic solution injection hole 15 in a position facing a valley portion S mentioned above, the electrolytic solution injection hole 15 is sealed by a sealing member 16. Then, the battery 100 includes an insulating member between the sealing plate 14 and the current collecting member in the height direction (the up-down direction Z), and a part of the insulating member is disposed in the valley portion S. Such a battery 100 can be manufactured by, for example, a manufacturing method including an assembling step, a battery sealing step, and an electrolytic solution injection hole sealing step. Note here that the manufacturing method disclosed herein may further include any other steps in optional stages.

Firstly, in the assembling step, an outer covering 12, the sealing plate 14, a plurality of (herein, three) wound electrode bodies 20, terminals (a positive electrode terminal 30 and a negative electrode terminal 40), current collecting members (a positive electrode first current collecting member 51 and a negative electrode first current collecting member 61), insulating members (a positive electrode insulating member 70 and a negative electrode insulating member 80) are prepared. The sealing plate 14 in which an electrolytic solution injection hole 15 is not formed on a center line CL2 in the short side direction X of the sealing plate 14 is herein prepared. Next, a first combined product as shown in FIG. 10 and FIG. 11 is prepared. Specifically, to the sealing plate 14 provided with the electrolytic solution injection hole 15, the positive electrode terminal 30, a positive electrode first current collecting member 51, the positive electrode insulating member 70, the negative electrode terminal 40, the negative electrode first current collecting member 61, and the negative electrode insulating member 80 are attached.

The positive electrode terminal 30, the positive electrode first current collecting member 51, and the positive electrode insulating member 70 are fixed to the sealing plate 14 by, for example, caulking (riveting). The caulking includes sandwiching the gasket 90 between an outer surface 14A side of the sealing plate 14 and the positive electrode terminal 30, and further sandwiching the positive electrode insulating member 70 between the inner surface 14B side of the sealing plate 14 and the positive electrode first current collecting member 51. Note here that the materials of the gasket 90 may be similar to those of the positive electrode insulating member 70. In details, the positive electrode terminal 30 before caulking is inserted from the upper part of the sealing plate 14, into the through hole of the gasket 90, the terminal extraction hole 18 of the sealing plate 14, the through hole 71h of the positive electrode insulating member 70, and a through hole 51h of the positive electrode first current collecting member 51 sequentially, and is allowed to protrude to the lower part of the sealing plate 14. Then, a portion protruding from the lower part of the sealing plate 14 of the positive electrode terminal 30 is caulked so that the pressure force is applied in the up-down direction Z. Thus, the positive electrode terminal 30, the positive electrode first current collecting member 51, the positive electrode insulating member 70, and the gasket 90 can be fixed to the sealing plate 14.

Fixing of the negative electrode terminal 40, the negative electrode first current collecting member 61, and the negative electrode insulating member 80 can be carried out in the same manner as for the positive electrode side. In other words, the negative electrode terminal 40 before caulking is sequentially inserted from the upper part of the sealing plate 14 into the through hole of the gasket, the terminal extraction hole 19 of the sealing plate 14, the through hole of the negative electrode insulating member 80, and the through hole of the negative electrode first current collecting member 61 to protrude into the lower part of the sealing plate 14. Then, a portion protruding to the lower part than the sealing plate 14 of the negative electrode terminal 40 is caulked so that the pressure force is applied in the up-down direction Z. Thus, the negative electrode terminal 40, the negative electrode first current collecting member 61, the negative electrode insulating member 80, and the gasket 90 can be fixed to the sealing plate 14.

Note here that fixing of the positive electrode insulating member 70 and the negative electrode insulating member 80 is not limited to the fixing by caulking as mentioned above. For example, fixing to the sealing plate 14 may be carried out using adhesive agents and the like, or fixing to the sealing plate 14 may be carried out by fitting.

Next, the positive electrode external conductive member 32 and the negative electrode external conductive member 42 are attached to the outer surface 14A of the sealing plate 14 via the outer insulating member 92. Note here that materials of the outer insulating member 92 may be the same as those for the positive electrode insulating member 70. Furthermore, the timing at which the positive electrode external conductive member 32 and the negative electrode external conductive member 42 are attached may be after sealing step of the electrolytic solution injection hole.

Then, by using the first combined product produced above, a second combined product as shown in FIG. 6 is produced. Specifically, firstly, as shown in FIG. 7, three wound electrode bodies 20 each of which is provided with the positive electrode second current collecting member 52 and the negative electrode second current collecting member 62 are prepared. Then, as shown in FIG. 6, three wound electrode bodies 20 are arranged in the three short side direction X. At this time, it is preferable that the wound electrode bodies 20 are arranged such that the winding axes WL are arranged in parallel.

Next, as shown in FIG. 4, the positive electrode first current collecting member 51 (in detail, the second region 51b) fixed to the sealing plate 14 and the positive electrode second current collecting member 52 of each of the wound electrode bodies 20 are joined in a state in which the plurality of positive electrode tabs 22t are curved. Furthermore, in a state in which a plurality of negative electrode tabs 24t of the negative electrode tab group 25 are curved, the negative electrode first current collecting member 61 fixed to the sealing plate 14 and the negative electrode second current collecting member 62 of each wound electrode body 20 are joined, respectively. Examples of the joining methods include welding such as ultrasonic welding, resistance welding, laser welding, or the like. In particular, welding by radiating high energy rays such as a laser is preferably used.

The battery sealing step includes housing the wound electrode bodies 20 integrated with the sealing plate 14 in the inner space of the outer covering 12, joining the sealing plate 14 to an edge of an opening 12h of the outer covering 12, and sealing the opening 12h. Specifically, firstly, for example, the electrode body holder 29 is prepared by bending an insulating resin sheet made of resin materials such as polyethylene (PE) in a bag shape or a box shape. Next, the wound electrode body 20 mentioned above is housed in the electrode body holder 29. The wound electrode body 20 covered with the electrode body holder 29 is inserted into the outer covering 12. Then, the sealing plate 14 is joined to the edge portion of the opening 12h of the outer covering 12 by welding, for example, laser welding to seal the opening 12h.

The sealing step of the electrolytic solution injection hole includes injecting the electrolytic solution, and then sealing the electrolytic solution injection hole 15 by the sealing member 16. Firstly, the sealing member 16 and the electrolytic solution are prepared. As the sealing member 16, a blind rivet is prepared. The blind rivet is not particularly limited, and may be the same as those conventionally used. In an example, the blind rivet includes a cylindrical sleeve that can be inserted into the electrolytic solution injection hole 15 in a state prior to processing (prior to sealing the electrolytic solution injection hole 15), a collar-shaped flange that extends from an end of the sleeve and has an outer diameter being larger than the electrolytic solution injection hole 15, a bag portion that is a part of the sleeve and is provided at an end portion on an opposite side to the flange, and a mandrel (a shaft) provided inside the sleeve and the bag portion. Furthermore, the electrolytic solution may be the same as those conventionally used in this type of secondary batteries and is not particularly limited.

Next, an electrolytic solution is injected from the electrolytic solution injection hole 15. Then, the prepared blind rivet is inserted into the electrolytic solution injection hole 15 of the sealing plate 14. Specifically, the sleeve of the blind rivet is inserted into the electrolytic solution injection hole 15 from a bag portion side. At the time when the blind rivet is inserted into the electrolytic solution injection hole 15 (in other words, at the time before caulking is carried out), the lower end portion of the inserted blind rivet may be positioned in the lower part than the lower end portion of the insulating member. Then, while the flange is pressed against the sealing plate 14, a portion of the mandrel that extends out from the flange is pulled upward using a tool or the like. Consequently, an inside of the bag portion is plastically deformed and, at the same time, the portion of the mandrel that extends out from the flange is cut off and eliminated. As a result, as shown in FIG. 8, an enlarged diameter portion 16c is formed at a lower end of the inserted portion 16a, the length in the up-down direction Z of the sealing member 16 is shortened. Thus, the lower end portion 70e of the positive electrode insulating member 70 is disposed in the lower part than the lower end portion 16e of the sealing member 16. Furthermore, the caulking may be carried out such that the maximum width portion 16d of the enlarged diameter portion 16c is located at sealing plate 14 side.

In the electrolytic solution injection hole sealing step, by carrying out the caulking as described above, the blind rivet as the sealing member 16 is fixed by caulking to the peripheral edge of the electrolytic solution injection hole 15, and at the same time, the electrolytic solution injection hole 15 is sealed by the sealing member 16. In this way, the battery 100 can be manufactured.

### <Applications of Battery>

While the battery mentioned above can be used in various applications, for example, the battery can be suitably used as a power supply (drive power supply) for a motor mounted on vehicles such as a passenger vehicle or a truck. While a type of the vehicle is not particularly limited, and examples thereof include a plug-in hybrid electric vehicle (PHEV), a hybrid electric vehicle (HEV), a battery electric vehicle (BEV), and the like. The battery can be suitably used in constructing the battery packs.

Although some embodiments of the present disclosure have been described above, the embodiments are only examples. The present disclosure can be implemented in various other forms. The present disclosure can be carried out on the basis of the contents disclosed in the present specification and common general technical knowledge in the relevant field. Techniques described in the claims include various modifications and changes of the embodiments shown above as examples. For example, a part of the embodiments described above may be replaced with another modification, or another modification may be added to the embodiments described above. Furthermore, if a technical feature is not described as essential, it can be deleted as appropriate.

### <First Modification>

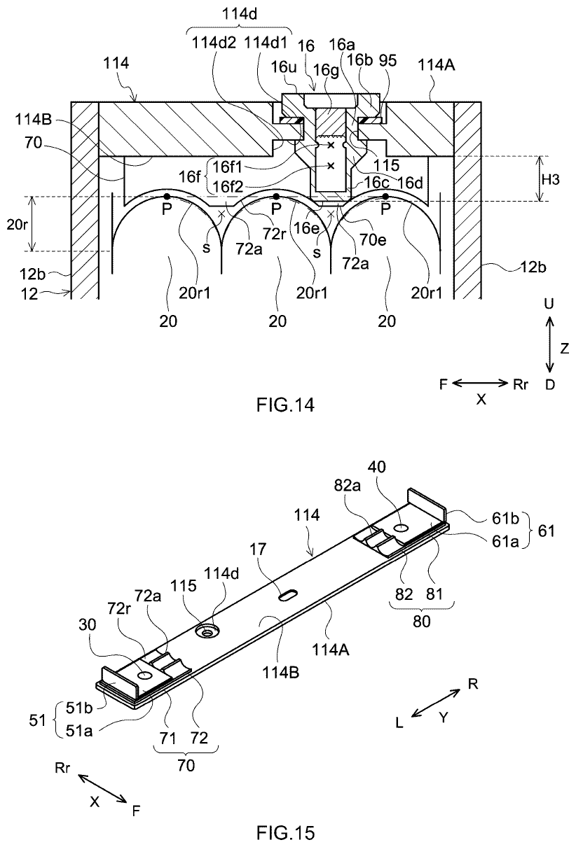

FIG. 14 is a view corresponding to FIG. 8 of a battery 200 in accordance with a first modification. FIG. 15 is a view corresponding to FIG. 11 of a battery 200 of in accordance with the first modification. As shown in FIG. 14 and FIG. 15, in the battery 200 in accordance with the first modification, a recessed portion 114d is provided around an electrolytic solution injection hole 115 at an inner surface 114B side of a sealing plate 114. In other words, the battery 200 includes the sealing plate 114 instead of the sealing plate 14. The battery 200 may have the same configuration except for these configurations.

The recessed portion 114d is provided so as to surround the periphery of the electrolytic solution injection hole 115. The recessed portion 114d is formed in a substantially circular shape that is larger than the electrolytic solution injection hole 115 in a plan view. In a plan view, the center of the recessed portion 114d coincides with the center of the electrolytic solution injection hole 115. The recessed portion 114d is recessed toward the outer surface 114A side from the inner surface 114B side of the sealing plate 114. As shown in FIG. 14, the recessed portion 114d includes a bottom surface 114d1 and a side wall 114d2. The bottom surface 114d1 is substantially parallel to the outer surface 114A of the sealing plate 114. The side wall 114d2 extends from the outer peripheral edge of the bottom surface 114d1 downward (toward the bottom surface 12a side) along the up-down direction Z. The side wall 114d2 herein rises at an approximately right angle from the bottom surface 114d1. However, an angle made by the bottom surface 114d1 and the side wall 114d2 may be an acute angle or an obtuse angle.

When a recessed portion 114d is provided in the inner surface 114B side of the sealing plate 114, at least a part of the enlarged diameter portion 16c of the sealing member 16 may be disposed inside the recessed portion 114d. Entire part of the enlarged diameter portion 16c may be inside the recessed portion 114d or may not be inside the recessed portion 114d. When at least a part of the enlarged diameter portion 16c is disposed inside the recessed portion 114d of the sealing plate 114, the length of the sealing member 16 protruding toward the wound electrode body 120 side can be shortened. In other words, the protruding length H3 of the sealing member 16 protruding from the lower end of the side wall 114d2 of the recessed portion 114d toward the valley portion S can be shortened. This configuration enables the upper end portion of the wound electrode body 20 to be disposed closer to the sealing plate 14, and the height of the wound electrode body 20 to be heightened. Thus, a capacity of the battery 200 can further be increased.

As mentioned above, specific embodiments of the technology disclosed herein include the following.
Item 1: A battery including a wound electrode body including a positive electrode and a negative electrode, and including a pair of curved portions; a battery case with a hexahedron shape housing a plurality of the wound electrode bodies, and including a bottom surface, a first surface with a substantially rectangular shape facing the bottom surface, a pair of first side walls facing each other and extending from the bottom surface, and a pair of second side walls facing each other and extending from the bottom surface; an electrolytic solution injection hole formed on the first surface of the battery case; a sealing member for sealing the electrolytic solution injection hole; and an insulating member fixed to the first surface, wherein the plurality of wound electrode bodies is disposed in the battery case in such a manner that in each of the plurality of wound electrode bodies, one curved portion of the pair of curved portions faces the first surface and another curved portion of the pair of curved portions faces the bottom surface, and the electrolytic solution injection hole is formed in a position that does not overlap with vertexes of the curved portions of the plurality of wound electrode bodies, and wherein a part of the insulating member is disposed in a valley portion surrounded by a surface linking the vertexes of the adjacent wound electrode bodies and the curved surfaces of the curved portions of the adjacent wound electrode bodies, and a part of the sealing member is disposed in the valley portion.
Item 2: The battery described in the item 1, wherein the insulating member includes a protruding portion protruding toward the valley portion, and the protruding portion is disposed in the valley portion.
Item 3: The battery described in the item 1 or 2, including a terminal disposed on the first surface, and a current collecting member electrically coupling the terminal to the positive electrode or the negative electrode, wherein the insulating member includes a protruding portion protruding toward the valley portion, and in a height direction of the battery case, the insulating member is sandwiched between the current collecting member and the first surface.
Item 4: The battery described in any one of the items 1 to 3, including a terminal attached to the first surface, and a current collecting member electrically coupling the terminal to the positive electrode or the negative electrode, wherein the insulating member includes a protruding portion formation region in which a plurality of the protruding portions is formed in a region that does not face the current collecting member in a middle side in a longitudinal direction of the first surface.
Item 5: The battery described in any one of the items 1 to 4, wherein the insulating member includes the protruding portion formation region in which a plurality of protruding portions is formed in the middle side in the longitudinal direction of the first surface, and that is not overlap with the current collecting member, wherein the protruding portion formation region includes a plurality of curved surfaces at a surface side facing the wound electrode body, the plurality of curved surfaces is formed between a plurality of the protruding portions, and the plurality of curved surfaces each has a shape along a respective bending surface of the wound electrode bodies.
Item 6: The battery described in any one of the items 1 to 5, wherein a lower end portion of the insulating member is disposed closer to the bottom surface side than a lower end portion of the sealing member.
Item 7: The battery described in any one of the items 1 to 6, wherein a number of the plurality of wound electrode bodies disposed in the battery case is an odd number, and the electrolytic solution injection hole is disposed in a position that does not overlap with a center line in a transverse direction of the first surface.
Item 8: The battery described in any one of the items 1 to 7, wherein the sealing member protrudes toward an inside of the battery case, and the sealing member includes a maximum width portion at the first surface side in a protruding direction.

What is claimed is:

1. A battery comprising:
a wound electrode body including a positive electrode and a negative electrode, and including a pair of curved portions;
a battery case with a hexahedron shape housing a plurality of the wound electrode bodies, the battery case including a bottom surface, a first surface with a substantially rectangular shape facing the bottom surface, a pair of first side walls facing each other and extending from the bottom surface, and a pair of second side walls facing each other and extending from the bottom surface;
an electrolytic solution injection hole formed on the first surface of the battery case;
a sealing member for sealing the electrolytic solution injection hole; and
an insulating member fixed to the first surface,
wherein the plurality of wound electrode bodies is disposed in the battery case in such a manner that in each of the plurality of wound electrode bodies, one curved portion of the pair of curved portions faces the first surface and another curved portion of the pair of curved portions faces the bottom surface, and
the electrolytic solution injection hole is formed in a position that does not overlap with vertexes of the curved portions of the plurality of wound electrode bodies, and
wherein a part of the insulating member is disposed in a valley portion surrounded by a surface linking the vertexes of the adjacent wound electrode bodies and the curved surfaces of the curved portions of the adjacent wound electrode bodies, and
a part of the sealing member is disposed in the valley portion.

2. The battery according to claim 1, wherein the insulating member includes a protruding portion protruding toward the valley portion, and the protruding portion is disposed in the valley portion.

3. The battery according to claim 1, comprising
a terminal disposed on the first surface, and
a current collecting member electrically coupling the terminal to the positive electrode or the negative electrode,
wherein in a height direction of the battery case, the insulating member is sandwiched between the current collecting member and the first surface.

4. The battery according to claim 3, wherein the insulating member includes a protruding portion protruding toward the valley portion, and a protruding portion formation region in which a plurality of the protruding portions is formed in a region that does not face the current collecting member in a middle side in a longitudinal direction of the first surface.

5. The battery according to claim 4, wherein
the protruding portion formation region includes a plurality of curved surfaces at a surface side facing the wound electrode body,
the plurality of curved surfaces is formed between a plurality of the protruding portions, and
the plurality of curved surfaces each has a shape along a respective bending surface of the wound electrode bodies.

6. The battery according to claim 1, wherein a lower end portion of the insulating member is disposed closer to the bottom surface side than a lower end portion of the sealing member.

7. The battery according to claim 1, wherein a number of the plurality of wound electrode bodies disposed in the battery case is an odd number, and the electrolytic solution injection hole is disposed in a position that does not overlap with a center line in a transverse direction of the first surface.

8. The battery according to claim 1, wherein the sealing member protrudes toward an inside of the battery case, and the sealing member includes a maximum width portion at the first surface side in a protruding direction.
